(19) United States
(12) Patent Application Publication
(10) Pub. No.: US 2026/0209547 A1
(43) Pub. Date: Jul. 23, 2026

(54) ALIPHATIC POLYUREA-POLYURETHANE COATINGS FOR POLYUREA-POLYURETHANE COMPOSITE STRUCTURES

(71) Applicant: American Polymers Corp., Santa Fe Springs, CA (US)

(72) Inventors: Dustin Le, Santa Fe Springs, CA (US); John Bender, Santa Fe Springs, CA (US); Ashish N. Dhuldhoya, Santa Fe Springs, CA (US); Shalesh Gupta, Santa Fe Springs, CA (US); Joe Camba, Santa Fe Springs, CA (US)

(21) Appl. No.: 19/452,664

(22) Filed: Jan. 19, 2026

Related U.S. Application Data
(60) Provisional application No. 63/748,378, filed on Jan. 22, 2025.

(51) Int. Cl. C09D 175/04; B29C 35/02; B29C 41/08; B29C 41/36; B29K 75/00; C08K 3/22; C09D 7/45; C09D 7/48; C09D 7/61; C09D 7/65; C09D 175/02

(52) U.S. Cl. CPC C09D 175/04; B29C 35/02; B29C 41/08; B29C 41/365; C08K 3/22; C09D 7/45; C09D 7/48; C09D 7/61; C09D 7/65; C09D 175/02; B29K 2075/02; B29K 2995/0022; B29K 2995/007; C08K 2003/2241

(57) ABSTRACT

Polyurea-polyurethane coatings, composite molded structures formed from the same, and methods for the manufacture thereof are disclosed. An isocyanate composition and a resin composition may be applied to a mold with a plural component spray system. The resin may include various components, such as a UV absorber, a dispersion agent, a flow agent, an air release agent, a crosslinking agent, a surface tension reducing agent, an anti-settling agent, an anti-oxidant, a moisture scavenger, a wetting agent, and a stain repellant additive. The compositions may react and cure to form the polyurea-polyurethane coating. Beneficially, this coating could be substantially free of pinholes, substantially free of volatile organic compounds, have a hardness greater than 55 shore D, and have a gloss reading ranging from 80 to 95 at 60 degrees.

### CROSS-REFERENCE TO RELATED APPLICATIONS

This present application relates to and claims the benefit of U.S. Provisional Application No. 63/748,378 filed Jan. 22, 2025, and entitled “ALIPHATIC POLYUREA-POLYURETHANE COATINGS FOR POLYUREA-POLYURETHANE COMPOSITE STRUCTURES,” the entire disclosure of which is hereby wholly incorporated herein by reference.

### STATEMENT RE: FEDERALLY SPONSORED RESEARCH/DEVELOPMENT

Not Applicable

### BACKGROUND

### 1. Field of Invention

The present application relates to polyurea/polyurethane coatings which may form part of a polyurea-polyurethane composite structure or be applied in a method of manufacturing such a structure. More specifically, the present application relates to fast curing aliphatic polyurea/polyurethane coatings which provide stain resistance, reduce pinholes, and minimizes the content of volatile organic compounds (VOCs) for polyurea-polyurethane composite structures produced from such coatings.

### 2. Related Art

Polyurea-polyurethane composite structures can be manufactured by applying one or more polyurea/polyurethane coatings upon a mold, usually via a reverse molding method. This is traditionally performed by applying (with, for example, a plural component spray gun) at least two components, including an isocyanate component and a resin component, on the outer surface of a mold. These components may be allowed to react upon a mold until they have cured to reach a level of hardness which would permit another polyurea/polyurethane coating to be applied. The order of application and the specific compounds of these coatings may determine the mechanical properties of the final composite structure formed upon the mold. By allowing all of the applied coatings to cure, the composite structure may be formed and subsequently removed from the mold and used as, for instance, a bathtub, a sink, a part of a boat, etc. Existing coatings and methods for manufacturing composite structure are disclosed in U.S. Pat. No. 7,001,948 entitled “Polyurea coating compositions,” U.S. Pat. No. 12,409,583 entitled “Sprayed multilayer polyurea and polyurethane composites”, and U.S. Patent Publication No. US 2025/0346024 A1 entitled “Composite polyurea structure and method of fabricating same,” the entire disclosures of each of which are wholly incorporated herein by reference.

It is usually desirable to manufacture a polyurea-polyurethane composite structure to have a gelcoat on the top, exposed surface of the composite structure. These gelcoats may serve to protect the composite structure from water, UV rays, etc., create an aesthetically pleasing smooth and glossy finish, and maintain the composite structure's integrity. A common gelcoat used for polyurea-polyurethane composite structures is a styrenated polyester resin coating. These gelcoats have a long gel time (sometimes referred to as an open time), which beneficially allows for any air entrapped during the spray application process to escape the film of the coating. By allowing the air to migrate in this manner, the cured gelcoat may contain less pinholes and less sharp edges along any pinholes which do exist; this is favorable because dirt and other types of debris may become caught in these pinholes and edges, thus staining the surface of the gelcoat. In addition, the long open time can permit the coating to flow and smooth out over the surface as it hardens so that the cured film has softer peaks and valleys; again, this curtails stain and dirt entrapment but also makes it easier to clean the surface of the composite structure. On the downside, the application of such gelcoats will inevitably cause styrene monomers, a volatile organic compound (VOC), to be released into the environment. Also, the lengthy cure time of these gelcoats adds delay to production times, and since these composite structures require extra layers of laminate to be sprayed onto the gelcoat once it has sufficiently cured, it is desirous for this cure time to be shortened.

U.S. Pat. No. 6,841,111, entitled “Method for making a polyurea-polyurethane composite structure substantially free of volatile organic compounds,” the disclosure of which is incorporated herein by reference, discloses methods of producing polyurea/polyurethane composite structures. The structures of this reference have an outer layer made from the reaction product of an aliphatic polyisocyanate and a polyamine which serves as an alternative to a styrenated polyester resin gelcoat. However, the resulting outer surfaces of these structures do not result in the glossiness as a conventional styrenated gelcoat would yield. As such, there exists a need for improved outer coatings for polyurea-polyurethane composite structures which are smooth and durable but cure quickly and do not contain a high concentration of VOCs.

### BRIEF SUMMARY

To solve these and other problems, polyurea-polyurethane coatings, composite structures containing those coatings, and methods for the manufacture of those structures are disclosed. The coating may be the cured reaction product of an isocyanate composition and a resin composition. The isocyanate composition may include aliphatic isocyanates, such as isophorone diisocyanate (IPDI), hexamethylene diisocyanate (HDI), hydrogenated MDI (H₁₂MDI), dimer polyisocyanates, trimer polyisocyanates, or combinations thereof. The resin composition may include a variety of components, including one or more of: UV absorbers, titanium dioxide, polyamines, dispersion agents, flow agents, air release agents, crosslinking agents, surface tension reducing agents, stain repellant additives, wetting agents, tertiary amine tin-based and metal catalysts combinations, and filler components.

The isocyanate and resin compositions may be applied to a mold with a plural component spray system via spraying the components onto a mold with a spray gun. To enhance the quality of the spray film while reducing chemical deposition speed and velocity of air entrapment into the compositions as they react upon the mold, the spray system may comprise a dry air and oil filter membrane media. The compositions may each independently be applied at a spray pressure ranging from 1,000 psi to 4,000 psi, and the compositions may each independently be sprayed at a temperature ranging from 90 degrees Fahrenheit to 160 degrees Fahrenheit. Once the coating cures, additional coatings may be applied to a previously applied coating and allowed themselves to cure. After one has applied all desired coatings, the final polyurea-polyurethane composite structure may be removed from the mold and used as, for example, a bathtub, a sink, a part of a boat, an automobile part, etc. Advantageously, a coating could be substantially free of pinholes, substantially free of volatile organic compounds (VOCs), have a hardness greater than 55 shore D, and have a gloss reading ranging from 80 to 95 at 60 degrees, thus rendering the coating a preferred choice compared to alternative gelcoats.

All of these embodiments are contemplated to be within the scope of this disclosure. These and other embodiments will become readily apparent to those skilled in the art from the following detailed description of the preferred embodiments, the disclosure not being limited to any particular preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts the application of an aliphatic polyurea/polyurethane coating onto a glass mold substrate with a plural component spray gun, according to the teachings of this present disclosure; and

FIGS. 2-4 show actual embodiments of cured polyurea/polyurethane coatings which have been removed from their molds.

### DETAILED DESCRIPTION

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities, unless a contrary intention is clearly stated.

Disclosed herein are aliphatic polyurethane/polyurea coatings, which may be the outer, exposed coating of a polyurea-polyurethane composite structure formed by the methods disclosed herein. The coating may be formed by the reaction of at least two compositions: an isocyanate composition and a resin composition, which could contain UV absorbers, titanium dioxide, polyamines, dispersion agents, flow agents, air release agents, crosslinking agents, surface tension reducing agents, stain repellant additives, wetting agents, tertiary amine tin-based and metal catalysts combinations, and filler components. The film formed from the cured coating may have several desirable properties, including minimal surface porosity, a smooth surface, less cracking (which may otherwise result from impact to the coating that could occur during shipping, for example), greater dirt and stain resistance, and reduced stain penetration into any sub-coating surfaces. Furthermore, the cured coating hardness may be greater than 55 shore D, and the gloss reading of the surface may range from 80 to 95 at 60 degrees. As such, these coatings may be used in place of styrenated gelcoats or non-VOC alternatives while employing benefits found in both.

A polyurea-polyurethane composite structure may be manufactured by the following method. A mold may be provided having an outer surface which may define a geometry corresponding to a composite structure to be formed. Alternatively, or additionally, an inner surface of the mold may define a geometry corresponding to the composite structure to be formed, but in most applications, reverse molding is preferred. At least two compositions, such as the isocyanate and resin compositions, may be applied to a surface of the mold such that the compositions react upon the surface of the mold and cured to form a coating.

The isocyanate composition may comprise aliphatic isocyanates. In particular, the isocyanate composition may comprise: isophorone diisocyanate (IPDI), hexamethylene diisocyanate (HDI), hydrogenated MDI (H₁₂MDI), dimer polyisocyanates, trimer polyisocyanates, or combinations thereof.

A resin composition may be a formulation of amine and hydroxyl terminated components and various other additives. In certain embodiments, the resin composition may comprise one or more of: a UV absorber, titanium dioxide, a polyamine, a dispersion agent, a flow agent, an air release agent, a crosslinking agent, a surface tension reducing agent, an anti-settling additive, an anti-oxidant, a moisture scavenger, a wetting agent, a stain repellant additive, a tertiary amine tin based and metal catalysts combination, and a filler.

The dispersion agent may be a urethane-based dispersion agent, and it could be ionic, such as a cationic dispersion agent. The dispersion agent may be present in the resin composition at a range from 0.01% to 10% by weight of the resin composition.

The flow agent may comprise silicone-based flow agents, including, but being not limited to, polydimethylsiloxane, acrylic-branched end group flow agents, linear-terminated end group flow agents, or combinations thereof. Flow agents may also be present in the resin composition at a range from 0.01% to 10% by weight of the resin composition.

The air release agent may comprise silicone base polymers and could be present in the resin composition at a range from 0.01% to 10% by weight of the resin composition.

Any crosslinking agents may be present in the resin composition at a range from 1% to 80% by weight of the resin composition. Types of crosslinking agents that may be used include, but are not limited to, linear crosslinking agents, branched crosslinking agents, hinder crosslinking agents, primary amines, secondary amines, and combinations thereof. Aliphatic diamine is a specific crosslinking agent that may be used in the context of this disclosure.

The surface tension reducing agent could come in the form of silicone-based compounds, slow boiling/evaporative solvents (e.g., glycol ethers and hydrocarbon solvents), or both. Such surface tension reducing agents could be present in the resin composition at a range from 1% to 50% by weight of the resin composition.

Anti-settling additives can be present in the resin composition at a range from 0.1% to 10% by weight of the resin composition. Silicon dioxide hydrophobic and surface treated with, for instance, a polydimethylsiloxane may be a suitable anti-settling additive.

Anti-oxidants may react with peroxy radicals, via donating a hydrogen atom, to prevent chain reactions from propagating. Anti-oxidants may be present in a resin composition such that they make up 0.1% to 10% by weight of the resin composition.

Suitable moisture scavengers include crystalline aluminosilicate based moisture scavengers. Any moisture scavengers may be present in the resin composition at a range from 1% to 15% by weight of the resin composition.

Wetting agents may comprise a mono-functional wetting agent, a di-functional wetting agent, a tri-functional wetting agent, or combinations thereof.

The stain repellant additives of a resin composition may be present at a range from 0.001% to 80% by weight of the resin composition. Stain repellant additives may comprise: a di-functional wetting agent, a tri-functional wetting agent, a quadro-functional wetting agent, or combinations thereof. Additionally, the stain repellant additives could come in the form of: a linear hydroxyl terminated silicon polymer, a branched hydroxyl terminated silicon polymer, a linear acrylic terminated silicon polymer, a branched acrylic terminated silicon polymer, a linear amine terminated silicon polymer, a branched amine terminated silicon polymer, or combinations thereof.

Sufficient filler may be included in the resin composition such that the filler ranges from 1% to 50% by weight of the combined weight of the resin composition and isocyanate compositions applied to a mold.

The compositions may be applied with a plural component spray system capable of applying the isocyanate and resin compositions onto a mold with a spray gun. Additionally, the plural component spray gun could comprise a dry air and oil filter membrane media, which could enhance the quality of the spray film while reducing chemical deposition speed and velocity of air entrapment into the compositions as they react upon the mold. The compositions may each independently be applied at a spray pressure ranging from 1,000 psi to 4,000 psi, and the compositions may each independently be sprayed at a temperature ranging from 90 degrees Fahrenheit to 160 degrees Fahrenheit. The reaction mixture may advantageously cure very quickly, less than 40 seconds, for example, yet remarkably result in a shiny, reflective surface which is substantially free of blemishes, pinholes, and entrapped air. After this coating cures, additional coatings may be successively applied to a previously applied coating and allowed to cure. These additional coatings may also be applied with plural component spray systems but could differ in the compositions applied. In particular, at least one of these coatings may be an elastomer structural foam. In this respect, coatings and methodologies used in the manufacture of polyurea-polyurethane composite structures, including those familiar to those skilled in the art, may be employed. Once all coatings have been applied and allowed to cure, the final polyurea-polyurethane composite structure may be removed from the mold. The resulting structure can be used in various applications, such as a bathtub, a sink, a part of a boat, an automobile part, and more.

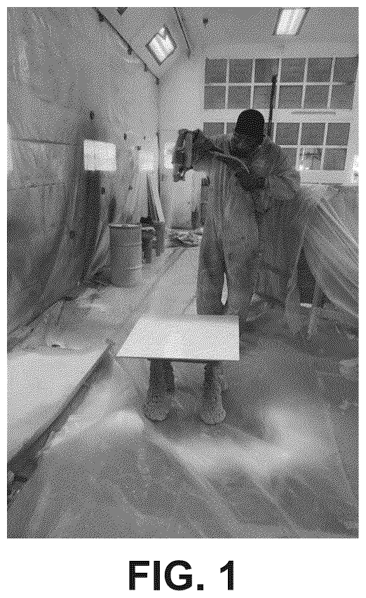

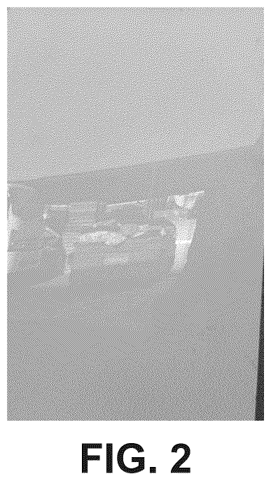

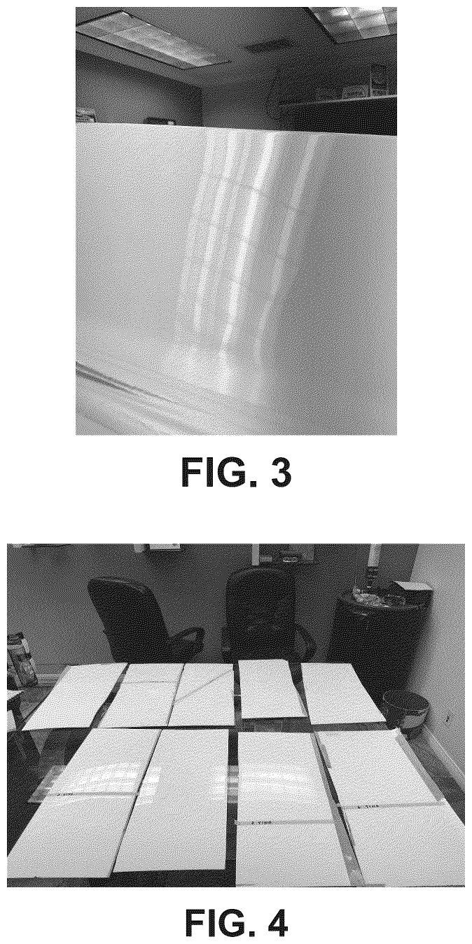

FIGS. 1-4 illustrate various aspects of the disclosure, including the manufacture of an aliphatic polyurea/polyurethane coating according to this disclosure as well as various views of actual cured coatings. FIG. 1 depicts the application of a polyurea/polyurethane coating onto a glass mold substrate with a plural component spray gun. FIGS. 2, 3 and 4 show the cured polyurea/polyurethane coatings which have been removed from their molds. It can be appreciated that these cured coatings are shiny, glossy, and mirror-like while being free of blemishes, pinholes, and entrapped air.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A polyurea-polyurethane coating comprising the cured reaction product of:
an isocyanate composition comprising: isophorone diisocyanate (IPDI), hexamethylene diisocyanate (HDI), hydrogenated MDI (H₁₂MDI), dimer polyisocyanates, trimer polyisocyanates, or combinations thereof; and
a resin composition comprising:
a UV absorber;
titanium dioxide;
a polyamine;
a dispersion agent;
a flow agent;
an air release agent;
a crosslinking agent;
a surface tension reducing agent;
an anti-settling agent;
an anti-oxidant;
a moisture scavenger;
a wetting agent;
a stain repellant additive;
a tertiary amine, tin based and metal catalysts combination; and
a filler;
wherein the coating has a hardness greater than 55 shore D; and
wherein the coating has a gloss reading ranging from 80 to 95 at 60 degrees.

2. The coating of claim 1, wherein the coating is substantially free of pinholes.

3. The coating of claim 1, wherein the coating is substantially free of volatile organic compounds (VOCs).

4. The coating of claim 1, wherein the wetting agent comprises a mono-functional wetting agent, a di-functional wetting agent, a tri-functional wetting agent, or combinations thereof.

5. The coating of claim 1, wherein the stain repellant additive comprises: a di-functional wetting agent, a tri-functional wetting agent, a quadro-functional wetting agent, or combinations thereof.

6. The coating of claim 1, wherein the stain repellant additive comprises: a linear hydroxyl terminated silicon polymer, a branched hydroxyl terminated silicon polymer, a linear acrylic terminated silicon polymer, a branched acrylic terminated silicon polymer, a linear amine terminated silicon polymer, a branched amine terminated silicon polymer, or combinations thereof.

7. A method of manufacturing a composite structure, the method comprising the steps of:
applying a first polyurea-polyurethane coating upon a surface of a mold, the surface defining a geometry corresponding to the composite structure to be manufactured, the polyurea-polyurethane coating being formed upon the mold via applying at least an isocyanate composition and a resin composition to the surface of the mold with a plural component spray system, the material pressures of the isocyanate composition and the resin composition each independently ranging from 1,000 psi to 4,000 psi when being applied, the temperature of the isocyanate composition and the resin composition each independently ranging from 90 degrees Fahrenheit to 160 degrees Fahrenheit when being applied, the plural component spray system comprising a dry air and oil filter membrane media, the polyurea-polyurethane coating comprising the cured reaction product of the isocyanate and resin compositions;
allowing the first polyurea-polyurethane coating to cure to form the composite structure; and
removing the composite structure from the mold;
wherein the isocyanate composition comprises: isophorone diisocyanate (IPDI), hexamethylene diisocyanate (HDI), hydrogenated MDI (H₁₂MDI), dimer polyisocyanates, trimer polyisocyanates, or combinations thereof; and
wherein the resin composition comprises:
a UV absorber;
titanium dioxide;
a polyamine;
a dispersion agent;
a flow agent;
an air release agent; a crosslinking agent; a surface tension reducing agent;
an anti-settling agent
an anti-oxidant;
a moisture scavenger;
a wetting agent;
and a stain repellant additive;
a tertiary amine, tin based and metal catalysts combination; and
a filler.

8. The method of claim 7, wherein the wetting agent comprises a mono-functional wetting agent, a di-functional wetting agent, a tri-functional wetting agent, or combinations thereof.

9. The method of claim 7, wherein the stain repellant additive comprises: a di-functional wetting agent, a tri-functional wetting agent, a quadro-functional wetting agent, or combinations thereof.

10. The method of claim 7, wherein the stain repellant additive comprises: a linear hydroxyl terminated silicon polymer, a branched hydroxyl terminated silicon polymer, a linear amine terminated silicon polymer, a branched amine terminated silicon polymer, or combinations thereof.

11. The method of claim 7, wherein the method further comprises the steps of:
applying an elastomer structural layer to the polyurea-polyurethane coating; and
allowing the elastomer structural layer to cure to further form the composite structure.

12. The method of claim 7, wherein the cured polyurea-polyurethane coating is substantially free of pinholes.

13. The coating of claim 7, wherein the cured polyurea-polyurethane coating is substantially free volatile organic compounds (VOCs).

14. The method of claim 7, wherein the surface of the mold is an outer surface of the mold.

15. The method of claim 7, wherein the cured polyurea-polyurethane coating has a hardness greater than 55 shore D.

16. The method of claim 7, the cured polyurea-polyurethane coating has a gloss reading ranging from 80 to 95 at 60 degrees.

17. The composite structure manufactured by the method of claim 7.
